(19) United States
(12) Patent Application Publication
(10) Pub. No.: US 2017/0055263 A1
(43) Pub. Date: Feb. 23, 2017

(54) BASE-STATION APPARATUS, TERMINAL APPARATUS, AND COMMUNICATION METHOD

(71) Applicant: SHARP KABUSHIKI KAISHA, Sakai City, Osaka (JP)

(72) Inventors: Hiromichi TOMEBA, Sakai City (JP); Jungo GOTO, Sakai City (JP); Osamu NAKAMURA, Sakai City (JP); Shiro WAKAHARA, Sakai City (JP); Yasuhiro HAMAGUCHI, Sakai City (JP)

(21) Appl. No.: 15/306,799

(22) PCT Filed: Apr. 14, 2015
(86) PCT No.: PCT/JP2015/061474

§ 371 Date: Oct. 26, 2016

(30) Foreign Application Priority Data
Apr. 30, 2014 (JP) 2014-093304

(51) Int. Cl. H04W 72/04; H04L 5/00

(52) U.S. Cl. CPC H04W 72/0453; H04L 5/0048; H04W 88/08

(57) ABSTRACT

Provided are a base-station apparatus, a terminal apparatus, and a communication method that make it possible to realize a LTE-A system which, while suppressing interference from an existing system, improves throughput by applying CA to an unlicensed band. The base-station apparatus of the invention is a base-station apparatus which is included in a communication system, in which a first communication scheme applied to a frequency band that is able to be used exclusively is applied to a frequency band that is not able to be used exclusively, and which is able to communicate with a terminal apparatus by using the frequency band that is able to be used exclusively and the frequency band that is not able to be used exclusively, in which a resource reservation signal which reserves the frequency band that is not able to be used exclusively is transmitted to the frequency band that is not able to be used exclusively based on a second communication scheme different from the first communication scheme, and the first communication scheme is applied to the frequency band that is not able to be used exclusively after the resource reservation signal is transmitted.

### TECHNICAL FIELD

The present invention relates to a base-station apparatus, a terminal apparatus, and a communication method.

### BACKGROUND ART

Standardization of the LTE (Long Term Evolution) system, which is a wireless communication system for 3.9th generation mobile phones, has been completed, and the LTE-A (LTE-Advanced, also referred to as IMT-A, for example) system as a more advanced version of the LTE system is now being standardized as one of 4th generation wireless communication systems.

In the LTE-A system (after LTE Rel. 10), a carrier aggregation (CA) technique in which one system band of the LTE system is set as a component carrier (CC, also referred to as a serving cell) and a plurality of CCs are simultaneously used has been adopted. When performing the CA, one CC is used as a primary cell (Pcell) which is able to realize all functions and other CCs are used as secondary cells (Scells).

Reservation of frequency resources is a significant problem in order for the LTE system to cope with a sudden increase of data traffics. A frequency band which has been assumed by the LTE system so far is a frequency band which is referred to as a so-called licensed band whose license is obtained from a country or an area where a cellular operator provides a service, and an available frequency band is limited.

Thus, it has been discussed recently to provide a LTE system using a frequency band which is referred to as a so-called unlicensed band which does not require a license from a country or an area (refer to NPL 1). By applying the CA technique adopted in the LTE-A system also to the unlicensed band, it is expected that a wider frequency band usable in the LTE-A system is able to be realized and a sudden increase in data traffics is able to be coped with efficiently.

### CITATION LIST

### Non Patent Literature

NPL 1: RP-140259, “Study on Licensed-Assisted Access using LTE”, 3GPP TSG RAN Meeting #63, March 2014.

### SUMMARY OF INVENTION

### Technical Problem

However, communication by a RAT (Radio access technology) different from the LTE may be performed in the unlicensed band as represented by the IEEE802.11 system. Thus, when the LTE-A system uses the unlicensed band with a similar control method to that of the licensed band simply by means of the CA technique, throughput is reduced due to, for example, interference from an existing system using the unlicensed band.

The invention has been made in view of such circumstances, and an object thereof is to provide a base-station apparatus a terminal apparatus, and a communication method that make it possible to realize a LTE-A system which, while suppressing interference from an existing system using an unlicensed band, improves throughput by performing a CA technique including an unlicensed band.

### Solution to Problem

A base-station apparatus, a terminal apparatus, and a communication method according to the invention for solving the aforementioned problems are as follows.

(1) That is, a base-station apparatus of the invention is a base-station apparatus which is included in a communication system, in which a first communication scheme applied to a frequency band that is able to be used exclusively is applied to a frequency band that is not able to be used exclusively, and which is able to communicate with a terminal apparatus by using the frequency band that is able to be used exclusively and the frequency band that is not able to be used exclusively, in which a resource reservation signal which reserves the frequency band that is not able to be used exclusively is transmitted to the frequency band that is not able to be used exclusively based on a second communication scheme different from the first communication scheme, and the first communication scheme is applied to the frequency band that is not able to be used exclusively after the resource reservation signal is transmitted.

With such a base-station apparatus, the first communication scheme is able to be applied to the frequency band that is not able to be used exclusively after the frequency band that is not able to be used exclusively is reserved, so that the base-station apparatus is able to reduce influence of interference from an existing system using an unlicensed band, thus making it possible to improve throughput of the communication system.

(2) The base-station apparatus of the invention is the base-station apparatus according to (1) above, in which control information associated with a signal transmitted in the frequency band that is not able to be used exclusively is transmitted to the terminal apparatus by using the frequency band that is able to be used exclusively.

With such a base-station apparatus, control information associated with a signal transmitted in the frequency band that is not able to be used exclusively is able to be transmitted by using the frequency band that is able to be used exclusively, so that it is possible to flexibly change a radio resource in which the control information is transmitted to the terminal apparatus, thus making it possible to improve throughput of the communication system.

(3) The base-station apparatus of the invention is the base-station apparatus according to (1) or (2) above, in which signaling indicating that the first communication scheme is applied to the frequency band that is not able to be used exclusively is sent in a higher layer to the terminal apparatus.

With such a base-station apparatus, the base-station apparatus is able to send signaling indicating that the first communication scheme is applied to the frequency band that is not able to be used exclusively in a higher layer to the terminal apparatus, so that the terminal apparatus is also able to start signal processing for the frequency band that is not able to be used exclusively based on the signaling, thus making it possible to reduce complexity of the terminal apparatus.

(4) The base-station apparatus of the invention is the base-station apparatus according to (3) above, in which the signaling includes information indicating a time period during which the frequency band that is not able to be used exclusively is occupied.

With such a base-station apparatus, a time period during which the frequency band that is not able to be used exclusively is occupied is able to be clearly indicated to the communication system, so that a radio resource is able to be used flexibly, thus making it possible to improve throughput of the communication system.

(5) The base-station apparatus of the invention is the base-station apparatus according to (4) above, in which the time period during which the frequency band that is not able to be used exclusively is occupied is longer than a signal length of a signal transmitted by using the frequency band that is not able to be used exclusively.

With such a base-station apparatus, the time period during which the frequency band that is not able to be used exclusively is occupied is longer than a signal length of a signal transmitted by using the frequency band that is not able to be used exclusively, so that it is possible to reduce influence of interference from an existing system using an unlicensed band, thus making it possible to improve throughput of the communication system.

(6) The base-station apparatus of the invention is the base-station apparatus according to (1) above, in which signaling of information indicating a radio resource in which at least a part of control information which is included in a signal transmitted in the frequency band that is not able to be used exclusively and which is associated with a signal transmitted in the frequency band that is not able to be used exclusively is arranged is sent to the terminal apparatus.

With such a base-station apparatus, signaling of information indicating a radio resource in which at least a part of control information which is included in a signal transmitted in the frequency band that is not able to be used exclusively and which is associated with a signal transmitted in the frequency band that is not able to be used exclusively is arranged is able to be sent to the terminal apparatus. Thus, the terminal apparatus is able to easily acquire the control information and complexity of the terminal apparatus is able to be reduced.

(7) The base-station apparatus of the invention is the base-station apparatus according to any one of (1) to (6) above, in which the resource reservation signal is CTS-to-self whose transmission source is the base-station apparatus.

With such a base-station apparatus, by transmitting CTS-to-self as the resource reservation signal, the frequency band that is not able to be used exclusively is reserved, so that it is possible to reduce influence of interference from an existing system using an unlicensed band, thus making it possible to improve throughput of the communication system.

(8) A terminal apparatus of the invention is a terminal apparatus that is able to communicate with a base-station apparatus which is included in a communication system, in which a first communication scheme applied to a frequency band that is able to be used exclusively is applied to a frequency band that is not able to be used exclusively, by using the frequency band that is able to be used exclusively and the frequency band that is not able to be used exclusively, in which monitoring of a control signal based on the first communication scheme is performed in the frequency band that is not able to be used exclusively.

Such a terminal apparatus is able to perform monitoring of a control signal based on the first communication scheme in the frequency band that is not able to be used exclusively. Thus, a signal transmitted by the base-station apparatus in the frequency band that is not able to be used exclusively is able to be received based on the control signal. Accordingly, it is possible to improve throughput of the communication system.

(9) The terminal apparatus of the invention is the terminal apparatus according to (8) above, in which a signal transmitted in the frequency band that is not able to be used exclusively from the base-station apparatus is demodulated based on control information transmitted by the base-station apparatus in the frequency band that is able to be used exclusively.

With such a terminal apparatus, a signal transmitted in the frequency band that is not able to be used exclusively from the base-station apparatus is able to be demodulated based on control information transmitted by the base-station apparatus in the frequency band that is able to be used exclusively, so that the base-station apparatus is able to flexibly change a radio resource in which the control information is transmitted to the terminal apparatus, thus making it possible to improve throughput of the communication system.

(10) The terminal apparatus of the invention is the terminal apparatus according to (8) or (9) above, in which signaling indicating that the first communication scheme is applied to the frequency band that is not able to be used exclusively is sent in a higher layer from the base-station apparatus, and the monitoring in the frequency band that is not able to be used exclusively is started based on the signaling.

With such a terminal apparatus, the monitoring in the frequency band that is not able to be used exclusively is started based on the signaling, thus making it possible to reduce complexity of signal processing concerning the monitoring.

(11) The terminal apparatus of the invention is the terminal apparatus according to (8) or (9) above, in which a resource reservation signal which is transmitted from the base-station apparatus based on a second communication scheme different from the first communication scheme and which reserves the frequency band that is not able to be used exclusively is able to be demodulated in the frequency band that is not able to be used exclusively, and the monitoring is started after the resource reservation signal is demodulated.

With such a terminal apparatus, the monitoring in the frequency band that is not able to be used exclusively is started based on the resource reservation signal, thus making it possible to reduce complexity of signal processing concerning the monitoring.

(12) The terminal apparatus of the invention is the terminal apparatus according to (11) above, in which a time period during which the frequency band that is not able to be used exclusively is occupied by the base-station apparatus is acquired from the resource reservation signal, and the monitoring is stopped based on the time period during which the frequency band is occupied.

Such a terminal apparatus is able to stop the monitoring in the frequency band that is not able to be used exclusively based on the resource reservation signal, thus making it possible to reduce complexity of signal processing concerning the monitoring.

(13) The terminal apparatus of the invention is the terminal apparatus according to (11) or (12) above, in which the resource reservation signal is CTS-to-self whose transmission source is the base-station apparatus.

Such a terminal apparatus is able to control the monitoring in the frequency band that is not able to be used exclusively based on the CTS-to-self, thus making it possible to reduce complexity of signal processing concerning the monitoring.

(14) A communication method of the invention is a communication method of a base-station apparatus which is included in a communication system, in which a first communication scheme applied to a frequency band that is able to be used exclusively is applied to a frequency band that is not able to be used exclusively, and which communicates with a terminal apparatus by using the frequency band that is able to be used exclusively and the frequency band that is not able to be used exclusively, the method including: a step of transmitting, based on a second communication scheme different from the first communication scheme, a resource reservation signal, which reserves the frequency band that is not able to be used exclusively, in the frequency band that is not able to be used exclusively, and a step of applying the first communication scheme to the frequency band that is not able to be used exclusively, after transmitting the resource reservation signal.

With such a communication method, the base-station apparatus is able to apply the first communication scheme to the frequency band that is not able to be used exclusively after reserving the frequency band that is not able to be used exclusively. Thus, the base-station apparatus is able to reduce influence of interference from an existing system using an unlicensed band, thus making it possible to improve throughput of the communication system.

(15) A communication method of the invention is a communication method of a terminal apparatus that communicates with a base-station apparatus which is included in a communication system, in which a first communication scheme applied to a frequency band that is able to be used exclusively is applied to a frequency band that is not able to be used exclusively, by using the frequency band that is able to be used exclusively and the frequency band that is not able to be used exclusively, the method including: a step of performing monitoring of a control signal based on the first communication scheme in the frequency band that is not able to be used exclusively.

With such a communication method, the terminal apparatus is able to perform monitoring of a control signal based on the first communication scheme in the frequency band that is not able to be used exclusively. Thus, a signal transmitted by the base-station apparatus in the frequency band that is not able to be used exclusively is able to be received based on the control signal. Accordingly, it is possible to improve throughput of the communication system.

(16) A base-station apparatus of the invention is the base-station apparatus according to claim (1) above, in which a signal bandwidth of the resource reservation signal and a signal bandwidth of a signal transmitted in the frequency band that is not able to be used exclusively after the resource reservation signal is transmitted are different.

Such a base-station apparatus is able to transmit a signal having a signal bandwidth different from a signal bandwidth of the resource reservation signal to the frequency band that is not able to be used exclusively after transmitting the resource reservation signal, thus making it possible to use resources flexibly and further improve throughput of the communication system.

According to the invention, a CA technique using an unlicensed band in addition to a licensed band is realized while minimizing interference from an existing system using an unlicensed band. As a result, it is possible to improve throughput of a communication system.

### BRIEF DESCRIPTION OF DRAWINGS

FIG. 1 illustrates one example of a communication system according to the invention.

FIG. 2 is a schematic block diagram illustrating one configuration example of a base-station apparatus of the invention.

FIG. 3 is a schematic block diagram illustrating one configuration example of each terminal apparatus of the invention.

FIG. 4 is a sequence chart illustrating one example of communication according to a first embodiment of the invention.

FIG. 5 is a sequence chart illustrating one example of communication according to a second embodiment of the invention.

### DESCRIPTION OF EMBODIMENTS

### 1. First Embodiment

A communication system in the present embodiment includes a base-station apparatus (transmission apparatus, cell, transmission point, transmission antenna group, transmit antenna port group, component carrier, evolved Node B (eNB), small base-station apparatus, Radio Remote Head (RRH)) and terminal apparatuses (terminal, mobile terminal, reception point, reception terminal, reception apparatus, receive antenna group, receive antenna port group, User Equipment (UE)).

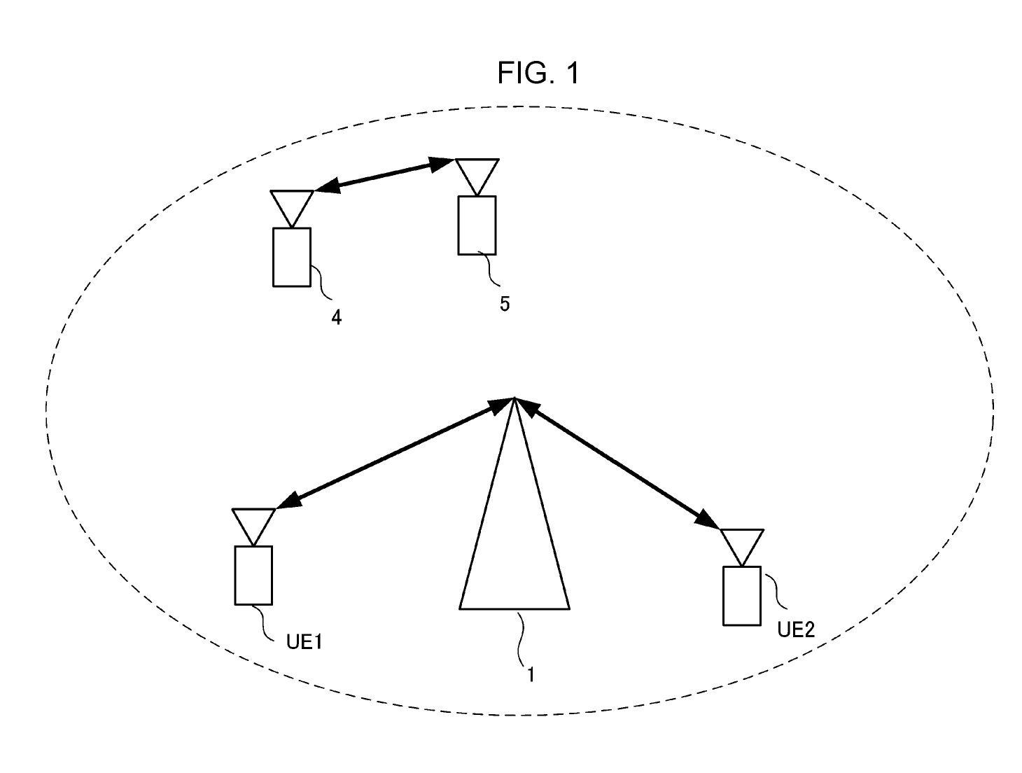

FIG. 1 is a schematic view illustrating one example of downlink of a cellular system according to a first embodiment of the invention. In the cellular system of FIG. 1, there are a base-station apparatus (eNB) 1 having a wide coverage (a long cell radius), a terminal apparatus UE1, and a terminal apparatus UE2 which are connected to the base-station apparatus 1. Moreover, there are also a STA (Station) 4 and a STA 5, which perform communication based on an existing IEEE 802.11 system (hereinafter, simply also referred to as an 802.11 system), in the coverage range of the base-station apparatus 1, and the STA 4 and the STA 5 may perform communication based on the 802.11 system in an unlicensed band. Here, the unlicensed band indicates a frequency band in which a cellular operator is able to provide a service without a license from a country or an area. That is, the unlicensed band is a frequency band that is not able to be used exclusively by a specific cellular operator. Note that, an apparatus which may perform communication based on an existing system (for example, Bluetooth (registered trademark)) using an unlicensed band other than the 802.11 system may exist in the coverage range of the base-station apparatus 1.

The terminal apparatus UE1 and the terminal apparatus UE2 are connected to the base-station apparatus 1 by using one of component carriers (serving cells) for performing communication with the base-station apparatus 1 as one Pcell (Primary cell) and use a licensed band as a frequency band. Here, the licensed band indicates a frequency band whose license is obtained from a country or an area in which a cellular operator provides a service. That is, the licensed band is a frequency band that is able to be used exclusively by a specific cellular operator.

The base-station apparatus 1 according to the present embodiment is able to utilize unlicensed bands, which are able to be used by the communication system, throughout all the frequency bands, and handles them as one channel. The base-station apparatus 1 sets (activation) a part of the unlicensed bands as a Scell (Secondary Cell) to the terminal apparatus UE1 and the terminal apparatus UE2, and performs data communication with the terminal apparatus UE1 and the terminal apparatus UE2 by means of CA. The base-station apparatus 1 is able to notify the terminal apparatus UE1 and the terminal apparatus UE2 that a LTE method may be applied to a part of the unlicensed bands. For example, the base-station apparatus 1 is able to include possibility of setting a part of the unlicensed bands as the Scell in a higher layer signal such as a signal transmitted in the Pcell or a RRC (Radio resource control) signal.

The terminal apparatus UE1 and the terminal apparatus UE2 according to the present embodiment are able to perform monitoring of a channel in which the base-station apparatus 1 transmits control information of downlink data transmission, for example, PDCCH (Physical Downlink Control Channel) not only in the licensed band but also in the unlicensed band. The monitoring of the PDCCH in each of the terminal apparatuses includes synchronization processing and blind decoding for decoding DCI (Downlink control information), which is downlink control information, in a CC in which the downlink control information may be transmitted. Each of the terminal apparatuses is able to start the monitoring of the PDCCH based on information indicating possibility that the LTE method is applied to a part of the unlicensed bands notified from the base-station apparatus 1. Each of the terminal apparatuses is also able to perform the monitoring of the PDCCH throughout all the unlicensed bands which are able to be used by the communication system.

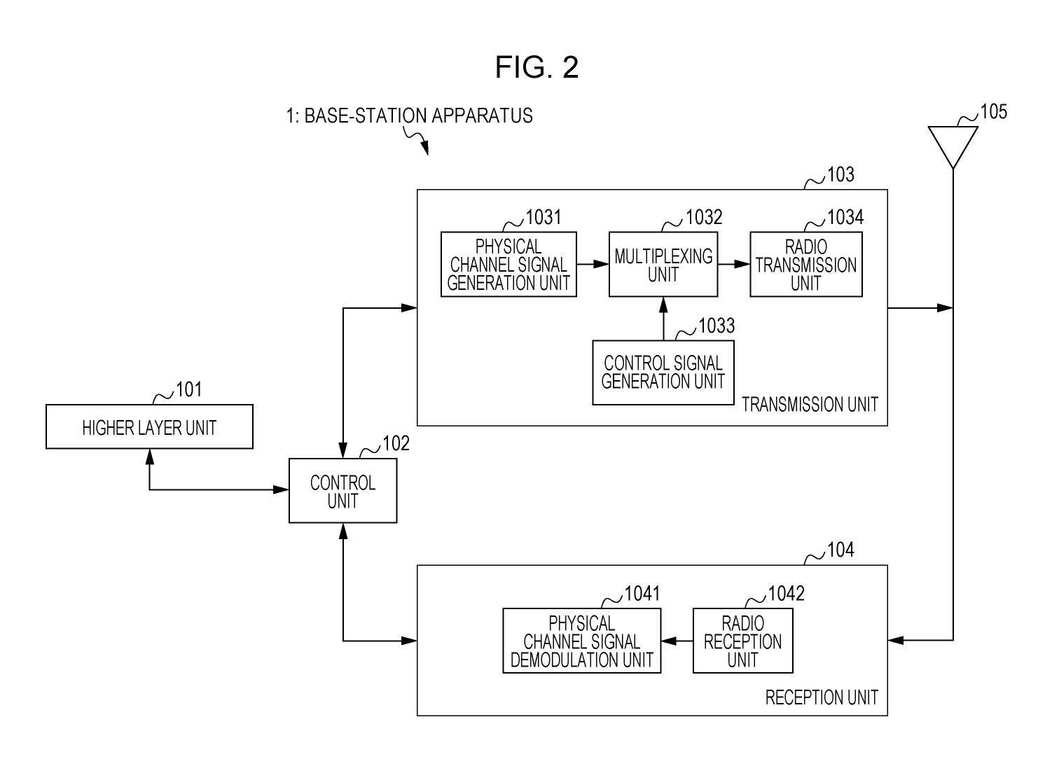

FIG. 2 is a block diagram illustrating one example of a configuration of the base-station apparatus 1 according to the first embodiment of the invention. As illustrated in FIG. 2, the base-station apparatus 1 includes a higher layer unit 101, a control unit 102, a transmission unit 103, a reception unit 104, and an antenna 105.

The higher layer unit 101 performs processing of a medium access control (MAC) layer, a packet data convergence protocol (PDCP) layer, a radio link control (RLC) layer, and a radio resource control (RRC) layer. The higher layer unit 101 generates information for performing control of the transmission unit 103 and the reception unit 104 and outputs it to the control unit 102. The higher layer unit 101 may have a function of outputting, to the control unit 102, information indicating possibility that the base-station apparatus 1 sets a part of the unlicensed bands as the Scell. The control unit 102 controls the higher layer unit 101, the transmission unit 103, and the reception unit 104.

The transmission unit 103 further includes a physical channel signal generation unit 1031, a multiplexing unit 1032, a control signal generation unit 1033, and a radio transmission unit 1034. The physical channel signal generation unit 1031 generates baseband signals to be transmitted by the base-station apparatus 1 in the Pcell and the Scell to the terminal apparatus UE1 and the terminal apparatus UE2. The signals generated by the physical channel signal generation unit 1031 include signals transmitted in the PDCCH of the Pcell and the Scell and PDSCH (Physical downlink shared channel) in which downlink data is transmitted. Note that, a downlink signal may also include, for example, CRS (Cell-specific Reference Signal) and CSI-RS (Channel State Information-Reference Signal) serving as EPDCCH (Enhanced Physical Downlink Control Channel) and a reference signal, and PSS/SSS (Primary Synchronization Signal/Secondary Synchronization Signal) serving as DMRS (De-Modulation Reference Signal) and a synchronization signal. Note that, an example in which the baseband signals to be transmitted to the terminal apparatus UE1 and the terminal apparatus UE2 are generated is indicated because the number of terminal apparatuses is two in FIG. 1, but the present embodiment is not limited thereto.

The multiplexing unit 1032 multiplexes a signal generated by the physical channel signal generation unit 1031 and a signal generated by the control signal generation unit 1033. In the present embodiment, the signal generated by the control signal generation unit 1033 will be described below.

The radio transmission unit 1034 performs processing for converting the baseband signals generated by the multiplexing unit 1032 into radio frequency (RF) band signals. The processing performed by the radio transmission unit 1034 includes digital/analog conversion, filtering, frequency conversion from the baseband to the RF band, and the like.

The antenna 105 transmits signals generated by the transmission unit 103 to the terminal apparatus UE1 and the terminal apparatus UE2.

The base-station apparatus 1 also has a function of receiving signals transmitted from the terminal apparatus UE1 and the terminal apparatus UE2. The antenna 105 receives the signals transmitted from the terminal apparatus UE1 and the terminal apparatus UE2 and outputs them to the reception unit 104.

The reception unit 104 includes a physical channel signal demodulation unit 1041 and a radio reception unit 1042. The radio reception unit 1042 converts RF band signals input from the antenna 105 to baseband signals. The processing performed by the radio reception unit 1042 includes frequency conversion from the RF band to the baseband, filtering, analog/digital conversion, and the like. The processing performed by the reception unit 104 may include a function of measuring peripheral interference in a specific frequency band to reserve the frequency band (carrier sense).

The physical channel signal demodulation unit 1041 demodulates the baseband signals output by the radio reception unit 1042. The signals demodulated by the physical channel signal demodulation unit 1041 include signals transmitted in PUCCH (Physical Uplink Control Channel) in which the terminal apparatus UE1 and the terminal apparatus UE2 transmit control information transmitted in uplink and PUSCH (Physical uplink shared channel) in which uplink data is transmitted. The physical channel signal demodulation unit 1041 is able to demodulate the uplink data transmitted in the PUSCH based on control information about uplink transmitted in the PDCCH. Further, the physical channel signal demodulation unit 1041 may include a carrier sense function.

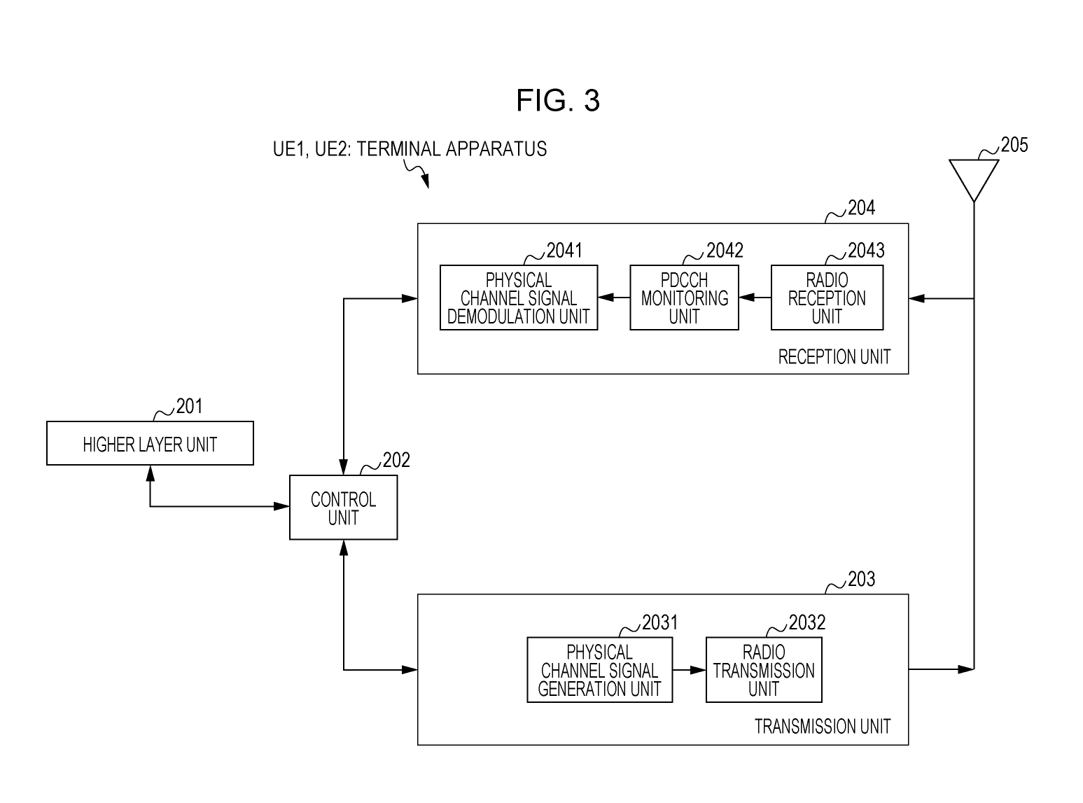

FIG. 3 is a block diagram illustrating one configuration example of the terminal apparatus UE1 and the terminal apparatus UE2 according to the present embodiment. As illustrated in FIG. 3, each of the terminal apparatus UE1 and the terminal apparatus UE2 includes a higher layer unit 201, a control unit 202, a transmission unit 203, a reception unit 204, and an antenna 205.

The higher layer unit 201 performs processing of a MAC layer, a PDCP layer, a RLC layer, and a RRC layer. The higher layer unit 201 generates information for performing control of the transmission unit 203 and the reception unit 204 and outputs it to the control unit 202.

The antenna 205 receives a signal transmitted by the base-station apparatus 1 and outputs it to the reception unit 204.

The reception unit 104 includes a physical channel signal demodulation unit 2041, a PDCCH monitoring unit 2042, and a radio reception unit 2043. The radio reception unit 2043 converts a RF band signal input from the antenna 205 into a baseband signal. The processing performed by the radio reception unit 2043 includes frequency conversion from the RF band to the baseband, filtering, analog/digital conversion, and the like.

The PDCCH monitoring unit 2042 performs monitoring of the PDCCH and the EPDCCH for the baseband signal output by the radio reception unit 2043 and acquires control information transmitted by the base-station apparatus 1 in the PDCCH and the EPDCCH. The PDCCH monitoring unit 2042 according to the present embodiment is able to perform monitoring of the PDCCH also in the unlicensed band. The PDCCH monitoring unit 2042 is able to perform the monitoring of the PDCCH throughout all the frequency bands in which DCI may be arranged by the base-station apparatus 1 in the unlicensed band.

The physical channel signal demodulation unit 2041 demodulates the baseband signal output by the radio reception unit 2043 based on the control information acquired by the PDCCH monitoring unit 2042. The signal demodulated by the physical channel signal demodulation unit 2041 includes a signal transmitted by the base-station apparatus 1 in the PDSCH. The physical channel signal demodulation unit 2041 is able to demodulate downlink data transmitted in the PDSCH based on DCI transmitted in the PDCCH or the EPDCCH.

Each of the terminal apparatus UE1 and the terminal apparatus UE2 also has a function of transmitting a signal. The antenna 205 transmits a RF band signal generated by the transmission unit 203 to the base-station apparatus 1.

The transmission unit 203 includes a physical channel signal generation unit 2031 and a radio transmission unit 2032. The physical channel signal generation unit 2031 generates baseband signals to be transmitted by the terminal apparatus UE1 and the terminal apparatus UE2 to the base-station apparatus 1. The signals generated by the physical channel signal generation unit 2031 include signals transmitted by the terminal apparatus UE1 and the terminal apparatus UE2 in the PUCCH and the PUSCH.

The radio transmission unit 2032 converts the baseband signals generated by the physical channel signal generation unit 2031 into RF band signals. The processing performed by the radio transmission unit 2032 includes digital/analog conversion, filtering, frequency conversion from the baseband to the RF band, and the like.

In the present embodiment, it is considered that the base-station apparatus 1 further performs CA (Carrier Aggregation) for the terminal apparatus UE1 and the terminal apparatus UE2 with a part of unlicensed bands as the Scell (Secondary cell). However, since the STA 4 and the STA 5 which perform existing 802.11 communication are in a coverage range of the base-station apparatus 1, when the base-station apparatus 1 simply uses a part of the unlicensed bands, mutual interference is caused.

Thus, the base-station apparatus 1 transmits a resource reservation signal, which reserves an unlicensed band in advance, by using the unlicensed band in at least a partial range of the coverage range of the base-station apparatus 1. Though a type and a transmission method of the resource reservation signal are not limited, the base-station apparatus 1 is able to generate and transmit the resource reservation signal based on an interference protection technique used in the 802.11 system, for example.

In the 802.11 system, an access scheme called CSMA/CA (Carrier sense multiple access with collision avoidance) which is an autonomous distributed control scheme is adopted. In the CSMA/CA, autonomous multiplexing access is realized in a case where each terminal apparatus measures peripheral interference (carrier sense) and performs communication when no interference is measured. However, a distance at which the carrier sense is able to be performed (which is called a carrier sense area) is limited, so that two terminal apparatuses which are out of mutual carrier sense areas perform transmission simultaneously to cause interference for other terminal apparatuses in some cases. Thus, some interference protection techniques are adopted in the 802.11 system.

In RTS/CTS (Request-to-send/clear-to-send), a terminal apparatus which desires transmission transmits RTS to a terminal apparatus which is a transmission destination. The terminal apparatus as the transmission destination of the RTS performs carrier sense after receiving the RTS, and when no interference is measured, transmits CTS to the terminal apparatus which has transmitted the RTS. At this time, terminal apparatuses other than the terminal apparatus as the transmission destination of the RTS that has received the RTS and terminal apparatuses other than the terminal apparatus as the transmission destination of the CTS that has received the CTS stop transmission of packets during a time period of NAV (Network allocation vector) that is set in advance. Thus, no interference is caused in the carrier sense area of at least the terminal apparatus as the transmission destination of the RTS and the terminal apparatus as the transmission destination of the CTS.

On the other hand, CTS-to-self is a function of transmitting CTS by a terminal apparatus, which is going to desire transmission, to the terminal apparatus itself. As described above, since terminal apparatuses other than the terminal apparatus as the transmission destination of the CTS that has received the CTS stop transmission of packets during the NAV, when the terminal apparatus transmits the CTS-to-self, no interference is caused from at least an area in which the CTS-to-self reaches.

Thus, before performing the CA with a part of unlicensed bands as the Scell, the base-station apparatus 1 according to the present embodiment transmits the CTS-to-self as a resource reservation signal in the unlicensed band. Therefore, the control signal generation unit 1033 of the base-station apparatus 1 generates a CTS-to-self signal according to a frame format of the 802.11 system. The multiplexing unit 1032 multiplexes the CTS-to-self signal generated by the control signal generation unit 1033 with a transmission signal so as to be transmitted from the unlicensed band. Thus, in the unlicensed band, the base-station apparatus 1 is to transmit a signal of a format different from a frame format of the LTE system, which is transmitted in a licensed band.

Both of the STA 4 and the STA 5 are able to recognize the CTS which is not addressed to the STA 4 and the STA 5 in the unlicensed band, so that transmission of packets is stopped during the NAV. Thus, the base-station apparatus 1 is able to reserve the unlicensed band for a fixed time period at least in a range in which the CTS-to-self transmitted by the base-station apparatus 1 reaches.

The base-station apparatus 1 performs the CA with the unlicensed band as the Scell after transmitting the CTS-to-self and performs data communication with any one or both of the terminal apparatus UE1 and the terminal apparatus UE2. At this time, the resource reservation signal transmitted by the base-station apparatus 1 and the signal transmitted by the base-station apparatus 1 in the Scell may have different bandwidths. The signal of the Pcell that is transmitted in the licensed band and the signal of the Scell that is transmitted in the unlicensed band may not be synchronized with each other. The terminal apparatus UE1 and the terminal apparatus UE2 are able to perform blind decoding of control information transmitted in the PDCCH of the Scell set by the base-station apparatus 1 and demodulate the PDSCH, in which downlink data of the Scell is transmitted, based on detected DCI. However, a method for detecting the control information may be different from a detection method in the case of the blind decoding. Moreover, each of the terminal apparatuses may receive notification of the unlicensed band, which may be used as the Scell, with control information of a higher layer from the base-station apparatus, and only when receiving the CTS-to-self in the designated Scell, perform detection of the control information.

Note that, the base-station apparatus 1 may transmit RTS or CTS as the resource reservation signal from the unlicensed band. Further, the control signal generation unit 1033 is able to describe a value of the NAV in frames of the CTS-to-self, the CTS, and the RTS which are transmitted in the unlicensed band. Since it is during the NAV that the base-station apparatus 1 is able to occupy the unlicensed band, the control unit 102 performs control so that a frame length of the signal transmitted in the Scell is shorter than that of the NAV described in the CTS-to-self by the control signal generation unit 1033. For example, since a data frame of the LTE method is constituted by subframes having a length of 1 millisecond (ms), the control unit 102 is able to select an integer N by which N ms is shorter than the NAV and set the frame length of the signal transmitted in the Scell as N ms. Moreover, the control unit 102 is also able to determine N in advance and then control the control signal generation unit 1033 so that the value of the NAV is longer than N ms.

Since the STA 4 and the STA 5 which perform carrier sense in an unlicensed band do not start communication while interference is observed in the unlicensed band, the base-station apparatus 1 is able to transmit, from the unlicensed band, a signal of a communication scheme different from the 802.11 system as a resource reservation signal. In this case, the resource reservation signal generated by the control signal generation unit 1033 may be a simple impulse signal or may be a part of a frame of an existing communication scheme. At this time, a bandwidth of the resource reservation signal generated by the control signal generation unit 1033 is not limited. For example, the control signal generation unit 1033 may set the bandwidth of the resource reservation signal as 20 MHz which is a bandwidth per one channel of the 802.11 system or as any of bandwidths of 1.4 MHz, 3 MHz, 5 MHz, 10 MHz, 15 MHz, and 20 MHz each of which is a bandwidth per 1 CC of the LTE system. Note that, the bandwidth of the resource reservation signal generated by the control signal generation unit 1033 and the bandwidth of the signal transmitted in the Scell may be different.

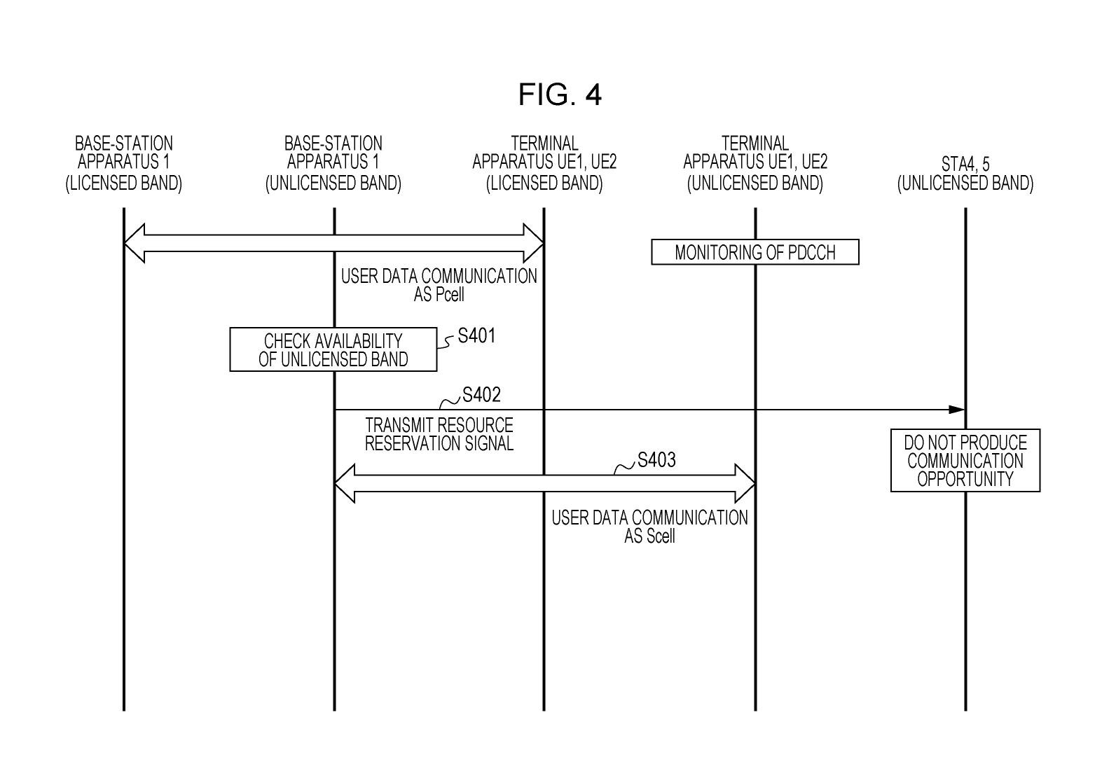

FIG. 4 is a sequence chart illustrating one example of communication in a licensed band and an unlicensed band between the base-station apparatus 1, the terminal apparatus UE1, and the terminal apparatus UE2 according to the present embodiment. It is assumed here that the terminal apparatus UE1 and the terminal apparatus UE2 are connected to the base-station apparatus 1 which is used as the Pcell, and use the licensed band as a frequency band. It is also assumed that the terminal apparatus UE1 and the terminal apparatus UE2 start monitoring of the PDCCH in all unlicensed bands, which may be used, based on information indicating possibility that the LTE method is applied to a part of unlicensed bands notified from the base-station apparatus 1.

For performing CA with an unlicensed band as the Scell, the base-station apparatus 1 firstly performs carrier sense in the unlicensed band and checks that communication is not performed in the unlicensed band in a carrier sense area (step S401). Thus, any one or both of the radio reception unit 1042 and the physical channel demodulation unit 1041 in the base-station apparatus 1 perform carrier sense in the unlicensed band, measure interfering power around the base-station apparatus 1, and output it to the control unit 102.

Next, on the basis of a result of the carrier sense, the base-station apparatus 1 transmits CTS-to-self in the unlicensed band based on a frame format of the 802.11 system (step S402). At this time, since the STA 4 and the STA 5 receive CTS which is not addressed to the STA 4 and the STA 5, communication is stopped during a time period of NAV after that.

Then, the base-station apparatus 1 performs data communication with the terminal apparatus UE1 and the terminal apparatus UE2 by the CA with the unlicensed band as the Scell (step S403). Step S403 includes processing that the terminal apparatus UE1 and the terminal apparatus UE2 demodulate downlink data transmitted in the PDSCH of the Scell by the base-station apparatus 1 based on the DCI transmitted in the PDCCH of the Scell, processing that the terminal apparatus UE1 and the terminal apparatus UE2 transmit signals, to be transmitted in the PUCCH and the PUSCH of the Scell to the base-station apparatus 1, based on the DCI transmitted in the PDCCH of the Scell, and the like. The above is one example of the communication according to the present embodiment.

Note that, the terminal apparatus UE1 and the terminal apparatus UE2 according to the present embodiment may further have a function of demodulating the CTS-to-self, the RTS, and the CTS transmitted by the base-station apparatus 1. In this case, though the terminal apparatus UE1 and the terminal apparatus UE2 perform monitoring of the PDCCH in the unlicensed band at all times in the aforementioned description, when the CTS-to-self includes information whose origin is the base-station apparatus 1 (transmitter address), the terminal apparatus UE1 and the terminal apparatus UE2 may further start monitoring of the PDCCH (that is, blind decoding) in unlicensed band in which the CTS-to-self is transmitted. The terminal apparatus UE1 and the terminal apparatus UE2 may start monitoring of the PDCCH not only in the unlicensed band in which the CTS-to-self is transmitted but also in all (or a part of) the unlicensed bands which are able to be used. Further, the terminal apparatus UE1 and the terminal apparatus UE2 may end the monitoring of the PDCCH after a time period (duration) reserved by the CTS or the CTS-to-self. The terminal apparatus UE1 and the terminal apparatus UE2 are able to read the time period reserved by the CTS or the CTS-to-self from the CTS or the CTS-to-self. By performing control in this manner, a time period for monitoring in the unlicensed band is able to be shortened. As a result, it is possible to suppress power consumption of the terminal apparatuses. In addition, based on the resource reservation signal transmitted in the unlicensed band by the base-station apparatus 1, such as the CTS-to-self, the terminal apparatus UE1 and the terminal apparatus UE2 may measure channel quality of the unlicensed band.

The base-station apparatus 1 according to the present embodiment may also have a function of transmitting a beacon defined by the 802.11 system in an unlicensed band. The beacon includes a plurality of pieces of information of apparatuses which have transmitted the beacon, such as service set ID indicating a transmission source. When the terminal apparatus UE1 and the terminal apparatus UE2 are able to demodulate the beacon, by setting contents of a plurality of pieces of information described in the beacon as a specific combination or describing specific information in the beacon, the base-station apparatus 1 is able to notify the terminal apparatus UE1 and the terminal apparatus UE2 of possibility that the LTE method is applied to the unlicensed band in which the beacon is transmitted. Further, the base-station apparatus 1 may generate the beacon so that the STA 4 or the STA 5 is not able to correctly demodulate a part of information, and output the beacon from the unlicensed band. In this case, when the beacon transmitted in the unlicensed band around the STA 4 or the STA 5 is only the beacon transmitted by the base-station apparatus 1, it is possible to reduce probability that the STA 4 and the STA 5 use the unlicensed band. That is, the base-station apparatus 1 according to the present embodiment is also able to use the beacon as the resource reservation signal.

Note that, when signals of the Pcell and the Scell are synchronized with each other, the base-station apparatus 1 may transmit control information for transmission of the PDSCH of the Scell by using the PDCCH of the Pcell to the terminal apparatus UE1 and the terminal apparatus UE2. The base-station apparatus may transmit control information for transmission of the PDSCH of the Scell by using the EPDCCH of the Pcell to the terminal apparatus UE1 and the terminal apparatus UE2.

When the base-station apparatus 1 continues the CA using the unlicensed band, the base-station apparatus 1 is able to continuously reserve the unlicensed band by transmitting the CTS-to-self periodically.

The base-station apparatus 1 is able to divide an unlicensed band into a plurality of frequency bands and transmit a resource reservation signal in each of the frequency bands. A method for dividing the unlicensed band by the base-station apparatus 1 (for example, such as a bandwidth per one band) is not limited, but, for example, the base-station apparatus 1 is able to divide the unlicensed band for each 20 MHz similarly to the 802.11 system. Moreover, the base-station apparatus 1 may use a center frequency (carrier frequency) of a plurality of unlicensed bands obtained by dividing for each 20 MHz as a frequency defined in the 802.11 system. The base-station apparatus 1 may divide the unlicensed band with a bandwidth per 1 CC of the LTE system as one unit. The base-station apparatus 1 is also able to determine the bandwidth per one band based on a signal bandwidth of the resource reservation signal generated by the control information generation unit 1033.

When a plurality of unlicensed bands are able to be used, the base-station apparatus 1 is able to determine a priority of applying CA to the plurality of unlicensed bands in advance. Then, the base-station apparatus 1 is able to send signaling of information associated with the priority of the plurality of unlicensed bands in a higher layer to the terminal apparatus UE1 and the terminal apparatus UE2 by means of RRC (Radio resource control) signal or the like.

For example, the higher layer unit 101 of the base-station apparatus 1 makes decision to use one predetermined unlicensed band preferentially among the plurality of unlicensed bands. Then, the base-station apparatus 1 is able to send signaling of information indicating the unlicensed band, which is used preferentially, to the terminal apparatus UE1 and the terminal apparatus UE2 in advance. By performing control in this manner, only a part of the plurality of unlicensed bands is used for the LTE system, so that the STA 4 and the STA 5 existing in the coverage range of the base-station apparatus 1 are able to perform communication based on the existing 802.11 system in other unlicensed bands which are not used for the LTE system. Moreover, the higher layer unit 101 of the base-station apparatus 1 is also able to make decision to use a predetermined plurality of unlicensed bands preferentially so as to reduce interference with the existing system using an unlicensed band.

Each of the terminal apparatus UE1 and the terminal apparatus UE2 according to the present embodiment may further have a function of transmitting a resource reservation signal. The base-station apparatus 1 may perform control so that the resource reservation signal is transmitted in the unlicensed band to the terminal apparatus UE1 and the terminal apparatus UE2 before a time period (duration) reserved by the CTS-to-self ends. The resource reservation signal transmitted by each of the terminal apparatuses may be RTS or CTS addressed to the base-station apparatus 1 or each of the terminal apparatuses or may be a simple impulse signal.

The DCI transmitted in the PDCCH of the Pcell or the Scell by the base-station apparatus 1 to the terminal apparatus UE1 and the terminal apparatus UE2 includes data transmitted in the PDSCH of the Pcell or the Scell by the base-station apparatus 1 to the terminal apparatus UE1 and the terminal apparatus UE2, and resource allocation information of data transmitted in the PUSCH of the Pcell or the Scell by the terminal apparatus UE1 and the terminal apparatus UE2. The resource allocation information includes information for designating a RB (Resource block) in which the data transmitted in the PDSCH and the PUSCH is arranged.

When transmitting the resource allocation information of the PDSCH of the Scell by using the PDCCH of the Pcell, the base-station apparatus 1 may associate the priority of unlicensed bands subjected to signaling in the higher layer by the base-station apparatus 1 with the resource allocation information. For example, the base-station apparatus 1 is able to generate the DCI so that a RB number transmitted in the PDCCH of the Pcell by the base-station apparatus 1 becomes a RB number in which the data transmitted in the PDSCH of the Scell is arranged according to the priority of unlicensed bands. Note that, when the base-station apparatus 1 transmits the resource allocation information of the PDSCH of the Scell by using the PDCCH of the Scell, the base-station apparatus 1 may ignore the priority of the unlicensed bands.

Note that, the base-station apparatus 1 may give the priority of the unlicensed bands to all the unlicensed bands which are able to be used. The base-station apparatus 1 may make the plurality of unlicensed bands into a plurality of groups formed by a plurality of bands in advance to give priority to each of the groups or give priority common between the groups. As a method for making the plurality of unlicensed bands into groups, the base-station apparatus 1 is able to make a group of unlicensed bands with 2.4 GHz band and a group of unlicensed bands with 5 GHz band, for example.

The base-station apparatus 1 may determine an unlicensed band, in which the resource reservation signal is transmitted, based on the priority of the unlicensed bands. For example, the base-station apparatus 1 may transmit the resource reservation signal only in one unlicensed band among the plurality of unlicensed bands which are able to be used.

When a plurality of unlicensed bands are able to be used, the base-station apparatus 1 is able to reduce the number of terminal apparatuses to be allocated to one unlicensed band. For example, the base-station apparatus 1 is able to perform resource allocation so as to allocate only one terminal apparatus (for example, the terminal apparatus UE1) to one unlicensed band. By performing control in this manner, an unlicensed band used for CA particularly in uplink is occupied by the LTE system only in a range in which an uplink signal of the terminal apparatus UE1 to which the unlicensed band is allocated reaches (which is called a coverage range of the terminal apparatus UE1). When the coverage range of the terminal apparatus UE1 is narrower than the coverage range of the base-station apparatus 1, an apparatus which exists in the coverage range of the base-station apparatus 1 but does not exist in the coverage range of the terminal apparatus UE1 is able to perform communication in the unlicensed band, for example, based on the 802.11 system.

The base-station apparatus 1 may periodically change the unlicensed band in which the resource reservation signal is transmitted. By performing control in this manner, no specific unlicensed band is occupied by the LTE system over a long time, so that a communication opportunity of an apparatus capable of communication only in the specific unlicensed band is reserved, for example.

The communication system according to the present embodiment may include a plurality of base-station apparatuses. In this case, priority of a plurality of unlicensed bands, which is given by each of the base-station apparatuses, is able to be given so that interference between the base-station apparatuses is reduced. For example, a frequency band in which a resource reservation signal is transmitted by each of the base-station apparatuses may be determined in accordance with a frequency repetition rule used in a general cellular system (such as three-cell repetition or seven-cell repetition). Note that, adjacent base-station apparatuses may transmit resource reservation signals in the same frequency band (that is, one-cell repetition) when interference between the base-station apparatuses is in an allowable range. Each of the base-station apparatuses may determine priority of frequency bands in which a resource reservation signal is transmitted based on performance of a connected terminal apparatus (for example, capability of suppressing inter-cell interference or the like).

According to the method described above, the base-station apparatus 1 is able to perform data communication with the terminal apparatus UE1 and the terminal apparatus UE2 by CA with the unlicensed band as the Scell while avoiding mutual interference with an existing system using the unlicensed band.

### 2. Second Embodiment

In the present embodiment as well, similarly to the first embodiment, it is assumed that the terminal apparatus UE1 and the terminal apparatus UE2 are connected are connected to the base-station apparatus 1 which is used as the Pcell and use a licensed band as a frequency band. Note that, an outline of a wireless communication system, a configuration of the base-station apparatus 1, and configurations of the terminal apparatus UE1 and the terminal apparatus UE2 in the present embodiment are the same as those of the first embodiment.

In the present embodiment, before performing CA using an unlicensed band, the base-station apparatus 1 sends signaling, which indicates that the CA using the unlicensed band is performed in advance, to the terminal apparatus UE1 and the terminal apparatus UE2 by a higher layer with use of the licensed band (for example, RRC).

Information to be signaled in the higher layer by the base-station apparatus 1 may be one-bit information indicating whether or not CA using the unlicensed band is performed. When the base-station apparatus 1 is able to use a plurality of unlicensed bands, information for designating an unlicensed band actually used by the base-station apparatus 1 for the CA or information for indicating priority of a plurality of unlicensed bands may be used. The information to be signaled in the higher layer by the base-station apparatus 1 is generated by the higher layer unit 101. The information to be signaled in the higher layer by the base-station apparatus 1 may include information indicating a time period during which the unlicensed band is occupied by the base-station apparatus 1.

The higher layer unit 201 of each of the terminal apparatus UE1 and the terminal apparatus UE2 determines whether or not monitoring of the PDCCH is performed in the unlicensed band based on the signaling in the higher layer by the base-station apparatus 1 and outputs control information to the control unit 202. For example, the higher layer unit 201 is able to output the control information to the control unit 202 so that the reception unit 204 recognizes, from the signaling of the higher layer from the base-station apparatus 1, that the base-station apparatus 1 may perform CA using an unlicensed band, and then starts monitoring of the PDCCH in the unlicensed band.

The higher layer unit 201 is also able to output the control information to the control unit 202 so that the reception unit 204 recognizes, from the signaling of the higher layer from the base-station apparatus 1, an unlicensed band actually used by the base-station apparatus 1 for CA or priority of a plurality of unlicensed bands, and then starts monitoring of the PDCCH in the unlicensed band.

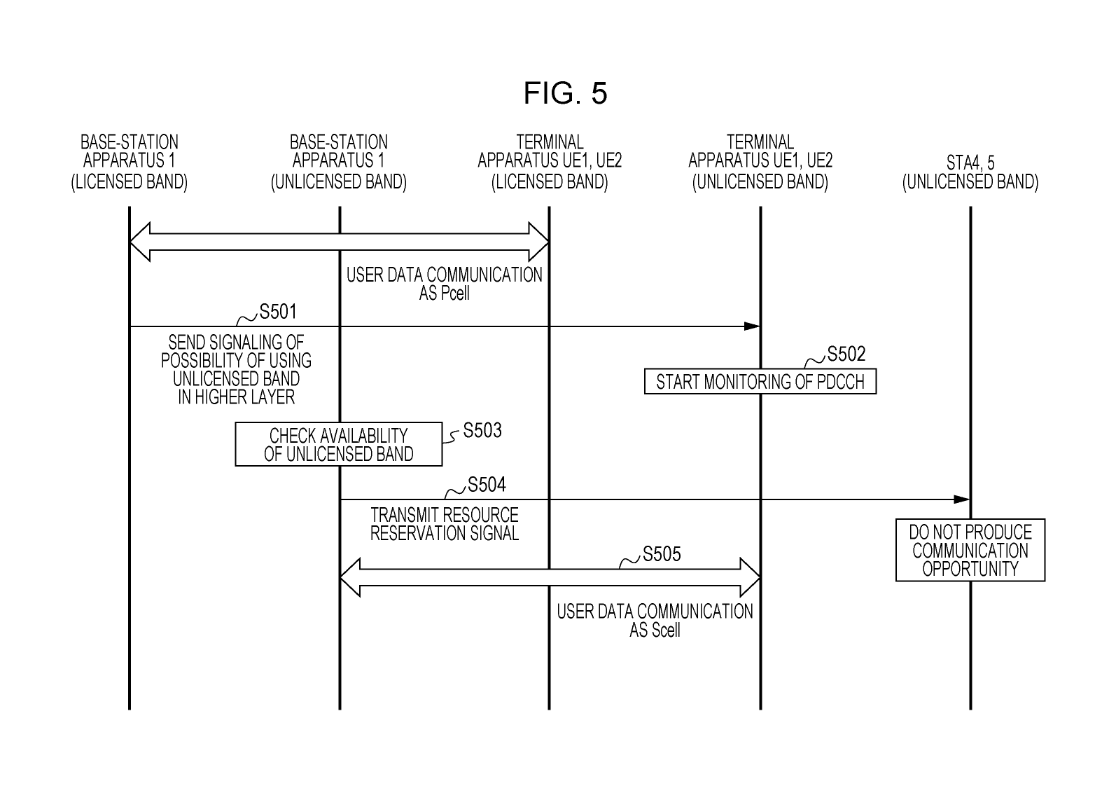

FIG. 5 is a sequence chart illustrating one example of communication in a licensed band and an unlicensed band between the base-station apparatus 1, the terminal apparatus UE1, and the terminal apparatus UE2 according to the present embodiment. It is assumed here that the terminal apparatus UE1 and the terminal apparatus UE2 are connected to the base-station apparatus 1 which is used as the Pcell and use the licensed band as a frequency band.

For performing CA with an unlicensed band as the Scell, the base-station apparatus 1 firstly sends signaling, which indicates that CA with a part of unlicensed bands as the Scell is performed, in a higher layer to the terminal apparatus UE1 and the terminal apparatus UE2 by using a licensed band (step S501).

Based on the signaling of the higher layer from the base-station apparatus 1, the terminal apparatus UE1 and the terminal apparatus UE2 start monitoring of the PDCCH in the unlicensed band (step S502). At this time, when recognizing, from the signaling of the higher layer from the base-station apparatus 1, the unlicensed band actually used by the base-station apparatus 1 for CA or priority of a plurality of unlicensed bands, the terminal apparatus UE1 and the terminal apparatus UE2 are able to perform monitoring of the PDCCH only in the unlicensed band.

Next, the base-station apparatus 1 performs carrier sense in the unlicensed band and checks that communication in the unlicensed band is not performed in a carrier sense area (step S503).

Then, the base-station apparatus 1 transmits a resource reservation signal (for example, CTS-to-self based on a frame format of the 802.11 system) in the unlicensed band (step S504). When the STA 4 and the STA 5 receive the CTS-to-self, the STA 4 and the STA 5 are able to grasp that the CTS-to-self is not addressed to the STA 4 and the STA 5, so that communication is stopped during a time period of NAV after that.

Subsequently, the base-station apparatus 1 performs data communication with the terminal apparatus UE1 and the terminal apparatus UE2 by the CA with the unlicensed band as the Scell (step S505). The terminal apparatus UE1 and the terminal apparatus UE2 demodulate downlink data transmitted by the base-station apparatus 1 in the PDSCH of the Scell based on DCI transmitted in the PDCCH of the Scell. Further, the terminal apparatus UE1 and the terminal apparatus UE2 transmit signals, to be transmitted in the PUCCH and the PUSCH of the Scell to the base-station apparatus 1, based on the DCI transmitted in the PDCCH of the Scell. The above is one example of communication according to the present embodiment.

Note that, the terminal apparatus UE1 and the terminal apparatus UE2 may stop the monitoring of the PDCCH according to the signaling from the higher layer. Thereby, it is possible to suppress power consumption by monitoring in unlicensed bands which are not used for communication by the base-station apparatus 1.

When the communication system is able to use a plurality of unlicensed bands, an unlicensed band in which monitoring of the PDCCH is performed by the PDCCH monitoring unit 2042 may be determined based on the signaling in the higher layer from the base-station apparatus 1.

When the terminal apparatus UE1 and the terminal apparatus UE2 have a function of receiving CTS-to-self, the PDCCH monitoring unit 2042 may start monitoring of the PDCCH only in the unlicensed band in which the radio reception unit 2043 receives the CTS-to-self or may perform monitoring preferentially in the unlicensed band in which the radio reception unit 2043 receives the CTS-to-self among unlicensed bands which are signaled in the higher layer from the base-station apparatus 1. At this time, the terminal apparatus UE1 and the terminal apparatus UE2 may stop monitoring of the PDCCH in the unlicensed band after a time period of NAV described in the CTS-to-self. By performing control in this manner, it is possible to reduce load (for example, power consumption) on the monitoring of the PDCCH by the terminal apparatus UE1 and the terminal apparatus UE2.

The monitoring of the PDCCH performed by the terminal apparatus UE1 and the terminal apparatus UE2 is not limited to blind decoding. For example, since the terminal apparatus UE1 and the terminal apparatus UE2 are able to grasp a radio resource in which at least a part of control information, which is transmitted by the base-station apparatus 1 in the PDCCH or the EPDDCH of the Scell (for example, control information arranged in a UE-specific search space), based on signaling in the higher layer from the base-station apparatus 1 or information of the PDCCH or the EPDDCH transmitted by the base-station apparatus 1 in the Pcell, the PDCCH monitoring unit 2042 is also able to directly read DCI from the radio resource.

The base-station apparatus 1 may use the EPDCCH of the Scell to transmit control information for demodulating the PDSCH transmitted in the Scell. At this time, the terminal apparatus UE1 and the terminal apparatus UE2 are able to demodulate the EPDCCH of the Scell based on control information transmitted by the base-station apparatus 1 in the PDCCH and the EPDCCH of the Pcell and signaling from the higher layer.

As described above, according to a method of the present embodiment, timing and a frequency band for performing monitoring of the PDCCH in the unlicensed band by the terminal apparatus UE1 and the terminal apparatus UE2 are able to be grasped in advance from signaling of the higher layer from the base-station apparatus 1, so that it is possible to reduce load on the monitoring of the PDCCH by the terminal apparatus UE1 and the terminal apparatus UE2.

### 3. Common in all Embodiments

Note that, a program which runs in the base-station apparatus and the terminal apparatus according to the invention is a program that controls a CPU and the like (program that causes a computer to function) such that the functions in the aforementioned embodiments concerning the invention are realized. The pieces of information handled by the apparatuses are temporarily accumulated in a RAM during the processing thereof, and then stored in various ROMs and HDDs and read, corrected, and written by the CPU when necessary. A recording medium that stores the program therein may be any of a semiconductor medium (for example, a ROM, a nonvolatile memory card or the like), an optical recording medium (for example, a DVD, an MO, an MD, a CD, a BD or the like), a magnetic recording medium (for example, a magnetic tape, a flexible disc or the like), and the like. Moreover, there is also a case where, by executing the loaded program, not only the functions of the aforementioned embodiments are realized, but also by performing processing in cooperation with an operating system, other application programs or the like based on an instruction of the program, the functions of the invention are realized.

When being distributed in the market, the program is able to be stored in a portable recording medium and distributed or be transferred to a server computer connected through a network such as the Internet. In this case, a storage apparatus of the server computer is also included in the invention. A part or all of the terminal apparatuses and the base-station apparatus in the aforementioned embodiments may be realized as an LSI which is a typical integrated circuit. Each functional block of a reception apparatus may be individually formed into a chip, or a part or all thereof may be integrated and formed into a chip. When each functional block is made into an integrated circuit, an integrated circuit control unit for controlling them is added.

Further, a method for making into an integrated circuit is not limited to the LSI and a dedicated circuit or a versatile processor may be used for realization. Further, in a case where a technique for making into an integrated circuit in place of the LSI appears with advance of a semiconductor technique, an integrated circuit by the technique is also able to be used.

Note that, the invention of the present application is not limited to the aforementioned embodiments. The terminal apparatus of the present application is not limited to be applied to a mobile station apparatus, but, needless to say, is applicable to stationary or unmovable electronic equipment which is installed indoors or outdoors such as, for example, AV equipment, kitchen equipment, cleaning/washing machine, air conditioning equipment, office equipment, automatic vending machine, other domestic equipment, and the like.

As above, the embodiments of the invention have been described in detail with reference to drawings, but specific configurations are not limited to the embodiments, and a design and the like which are not departed from the main subject of the invention are also included.

### INDUSTRIAL APPLICABILITY

The invention is suitably used for a base-station apparatus, a terminal apparatus, and a communication method.

Note that, the present international application claims priority from Japanese Patent Application No. 2014-093304 filed on Apr. 30, 2014, and the entire contents of Japanese Patent Application No. 2014-093303 are hereby incorporated herein by reference.

### REFERENCE SIGNS LIST

1 base-station apparatus
UE1, UE2 terminal apparatus
4, 5 STA
101, 201 higher layer unit
102, 202 control unit
103, 203 transmission unit
104, 204 reception unit
105, 204 antenna
1031, 2031 physical channel signal generation unit
1032 multiplexing unit
1033 control signal generation unit
1034, 2032 radio transmission unit
1041, 2041 physical channel signal demodulation unit
1042, 2043 radio reception unit
2042 PDCCH monitoring unit

1. A base-station apparatus which is included in a communication system, in which a first communication scheme applied to a frequency band that is able to be used exclusively is applied to a frequency band that is not able to be used exclusively, and which is able to communicate with a terminal apparatus by using the frequency band that is able to be used exclusively and the frequency band that is not able to be used exclusively, wherein
a resource reservation signal which reserves the frequency band that is not able to be used exclusively is transmitted to the frequency band that is not able to be used exclusively based on a second communication scheme different from the first communication scheme, and
the first communication scheme is applied to the frequency band that is not able to be used exclusively after the resource reservation signal is transmitted.

2. The base-station apparatus according to claim 1, wherein control information associated with a signal transmitted in the frequency band that is not able to be used exclusively is transmitted to the terminal apparatus by using the frequency band that is able to be used exclusively.

3. The base-station apparatus according to claim 1, wherein signaling indicating that the first communication scheme is applied to the frequency band that is not able to be used exclusively is sent in a higher layer to the terminal apparatus.

4. The base-station apparatus according to claim 3, wherein the signaling includes information indicating a time period during which the frequency band that is not able to be used exclusively is occupied.

5. The base-station apparatus according to claim 4, wherein the time period during which the frequency band that is not able to be used exclusively is occupied is longer than a signal length of a signal transmitted by using the frequency band that is not able to be used exclusively.

6. The base-station apparatus according to claim 1, wherein signaling of information indicating a radio resource in which at least a part of control information which is included in a signal transmitted in the frequency band that is not able to be used exclusively and which is associated with a signal transmitted in the frequency band that is not able to be used exclusively is arranged is sent to the terminal apparatus.

7. The base-station apparatus according to claim 1, wherein the resource reservation signal is CTS-to-self whose transmission source is the base-station apparatus.

8. A terminal apparatus that is able to communicate with a base-station apparatus which is included in a communication system, in which a first communication scheme applied to a frequency band that is able to be used exclusively is applied to a frequency band that is not able to be used exclusively, by using the frequency band that is able to be used exclusively and the frequency band that is not able to be used exclusively, wherein
monitoring of a control signal based on the first communication scheme is performed in the frequency band that is not able to be used exclusively.

9. The terminal apparatus according to claim 8, wherein a signal transmitted in the frequency band that is not able to be used exclusively from the base-station apparatus is demodulated based on control information transmitted by the base-station apparatus in the frequency band that is able to be used exclusively.

10. The terminal apparatus according to claim 8, wherein signaling indicating that the first communication scheme is applied to the frequency band that is not able to be used exclusively is sent in a higher layer from the base-station apparatus, and the monitoring in the frequency band that is not able to be used exclusively is started based on the signaling.

11. The terminal apparatus according to claim 8, wherein a resource reservation signal which is transmitted from the base-station apparatus based on a second communication scheme different from the first communication scheme and which reserves the frequency band that is not able to be used exclusively is able to be demodulated in the frequency band that is not able to be used exclusively, and the monitoring is started after the resource reservation signal is demodulated.

12. The terminal apparatus according to claim 11, wherein a time period during which the frequency band that is not able to be used exclusively is occupied by the base-station apparatus is acquired from the resource reservation signal, and the monitoring is stopped based on the time period during which the frequency band is occupied.

13. The terminal apparatus according to claim 11, wherein the resource reservation signal is CTS-to-self whose transmission source is the base-station apparatus.

14. A communication method of a base-station apparatus which is included in a communication system, in which a first communication scheme applied to a frequency band that is able to be used exclusively is applied to a frequency band that is not able to be used exclusively, and which communicates with a terminal apparatus by using the frequency band that is able to be used exclusively and the frequency band that is not able to be used exclusively, the method comprising:
a step of transmitting, based on a second communication scheme different from the first communication scheme, a resource reservation signal, which reserves the frequency band that is not able to be used exclusively, in the frequency band that is not able to be used exclusively, and
a step of applying the first communication scheme to the frequency band that is not able to be used exclusively, after transmitting the resource reservation signal.

15. A communication method of a terminal apparatus that communicates with a base-station apparatus which is included in a communication system, in which a first communication scheme applied to a frequency band that is able to be used exclusively is applied to a frequency band that is not able to be used exclusively, by using the frequency band that is able to be used exclusively and the frequency band that is not able to be used exclusively, the method comprising:
a step of performing monitoring of a control signal based on the first communication scheme in the frequency band that is not able to be used exclusively.

16. The base-station apparatus according to claim 1, wherein a signal bandwidth of the resource reservation signal and a signal bandwidth of a signal transmitted in the frequency band that is not able to be used exclusively after the resource reservation signal is transmitted are different.
